(19) United States
(12) Patent Application Publication
(10) Pub. No.: US 2005/0165938 A1
(43) Pub. Date: Jul. 28, 2005

(54) Method, system, and program for managing shared resources

(76) Inventor: Linden Cornett, Portland, OR (US)

Correspondence Address: KONRAD RAYNES & VICTOR, LLP, 315 S. BEVERLY DRIVE, # 210, BEVERLY HILLS, CA, 90212, US

(21) Appl. No.: 10/745,977

(22) Filed: Dec. 24, 2003

(51) Int. Cl. G06F 15/16

(52) U.S. Cl. 709/229

(57) ABSTRACT

Provided are a method, system, and program for managing shared resources such as, for example, a transport offload engine of a network adapter having a plurality of ports and a driver for each port. Lock logic permits each driver or other user to set a flag to request use of the shared resource. A grant flag may be set by the lock logic if no other user is using the shared resource. The shared resource may be released following completion of an operation by setting a clear flag in the lock logic for the shared resource.

### BACKGROUND OF THE INVENTION

1. Field of the Invention

The present invention relates to a method, system, and program for managing resources shared by different elements including drivers.

2. Description of the Related Art

In a network environment, a network adapter on a host computer, such as an Ethernet controller, Fibre Channel controller, etc., will receive Input/Output (I/O) requests or responses to I/O requests initiated from the host. Often, the host computer operating system includes a device driver to communicate with the network adapter hardware to manage I/O requests to transmit over a network. The host computer may also implement a protocol which packages data to be transmitted over the network into packets, each of which contains a destination address as well as a portion of the data to be transmitted. Data packets received at the network adapter are often stored in a packet buffer in the host memory. A transport protocol layer can process the packets received by the network adapter that are stored in the packet buffer, and access any I/O commands or data embedded in the packet.

For instance, the computer may implement the Transmission Control Protocol (TCP) and Internet Protocol (IP) to encode and address data for transmission, and to decode and access the payload data in the TCP/IP packets received at the network adapter. IP specifies the format of packets, also called datagrams, and the addressing scheme. TCP is a higher level protocol which establishes a connection between a destination and a source. Another protocol, Remote Direct Memory Access (RDMA) establishes a higher level connection and permits, among other operations, direct placement of data at a specified memory location at the destination.

A device driver, application or operating system can utilize significant host processor resources to handle network transmission requests to the network adapter. One technique to reduce the load on the host processor is the use of a TCP/IP Offload Engine (TOE) in which TCP/IP, RDMA and other protocol related operations are implemented in the network adapter hardware as opposed to the device driver or other host software, thereby saving the host processor from having to perform some or all of the TCP/IP protocol related operations.

A network adapter can have more than one port such that more than one physical connection can be made to a network. In some applications, the network adapter hardware is duplicated for each port. However, some adapter hardware such as a TOE can be relatively expensive to duplicate for each port.

In some applications, a separate driver is typically provided for each physical interface. Where the occasion arises for one driver to communicate with another driver, such communication between drivers often occurs through software procedures which provide a communication path between the drivers. One such known software procedure is referred to as a registered callback. Such software procedures are often complicated which can result in problems arising. Also, race conditions can arise.

There is a continued need in the art to improve the performance of network adapters.

### BRIEF DESCRIPTION OF THE DRAWINGS

Referring now to the drawings in which like reference numbers represent corresponding parts throughout:

FIG. 1 illustrates one embodiment of a computing environment in which aspects of the invention are implemented;

FIG. 2 illustrates a prior art packet architecture;

FIG. 3 illustrates an example of a lock logic for a shared resource, in accordance with aspects of the invention;

FIG. 4 illustrates a channel registration register for a shared resource, in accordance with aspect of the invention;

FIG. 5 illustrates one embodiment of operations performed to access a shared resource through a lock logic of FIG. 3, in accordance with aspects of the invention;

FIG. 6 illustrates one embodiment of operations performed to release a shared resource through a lock logic of FIG. 3, in accordance with aspects of the invention;

FIG. 7 illustrates an example of a message register shared resource and a lock logic for the message register shared resource, in accordance with aspects of the invention;

FIG. 8 illustrates one embodiment of operations performed in connection with accessing the message register of FIG. 7 by another driver;

FIG. 9 illustrates one embodiment of operations performed by another driver in response to the message stored in the message register of FIG. 7; and

FIG. 10 illustrates an architecture that may be used with the described embodiments.

### DETAILED DESCRIPTION OF THE ILLUSTRATED EMBODIMENTS

In the following description, reference is made to the accompanying drawings which form a part hereof and which illustrate several embodiments of the present invention. It is understood that other embodiments may be utilized and structural and operational changes may be made without departing from the scope of the present invention.

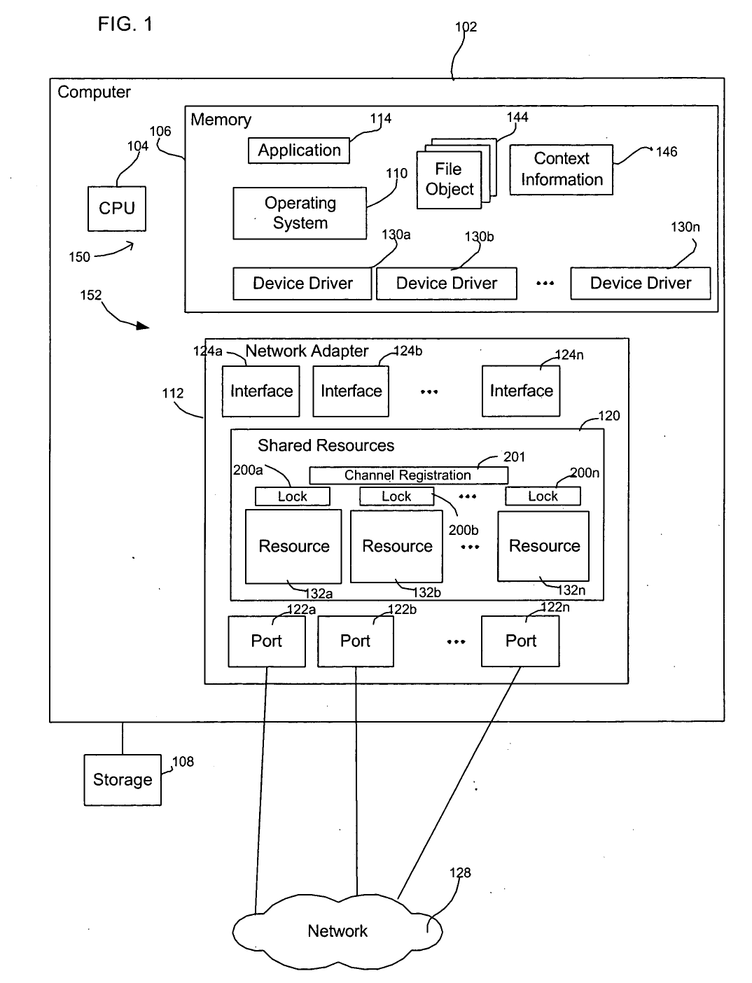

FIG. 1 illustrates a computing environment in which aspects of the invention may be implemented. A computer 102 includes one or more central processing units (CPU) 104 (only one is shown), a memory 106, non-volatile storage 108, an operating system 110, and a network adapter 112. An application program 114 further executes in memory 106 and is capable of transmitting and receiving packets from a remote computer. The computer 102 may comprise any computing device known in the art, such as a mainframe, server, personal computer, workstation, laptop, handheld computer, telephony device, network appliance, virtualization device, storage controller, network controller, etc. Any CPU 104 and operating system 110 known in the art may be used. Programs and data in memory 106 may be swapped into storage 108 as part of memory management operations.

The network adapter 112 includes shared resources 120 and non-shared resources including ports 122a, 122b . . . 122n and network adapter interfaces 124a, 124b, . . . 124n. The shared resources 120 can provide a network protocol layer to send and receive network packets to and from remote devices over a network 128. The network 128 may comprise a Local Area Network (LAN), the Internet, a Wide Area Network (WAN), Storage Area Network (SAN), etc. Embodiments may be configured to transmit data over a wireless network or connection, such as wireless LAN, Bluetooth, etc. In certain embodiments, the network adapter 112 and various protocol layers may implement the Ethernet protocol including Ethernet protocol over unshielded twisted pair cable, token ring protocol, Fibre Channel protocol, Infiniband, Serial Advanced Technology Attachment (SATA), parallel SCSI, serial attached SCSI cable, etc., or any other network communication protocol known in the art.

The computer 102 further includes a plurality of device drivers 130a, 130b . . . 130n, one for each port 122a, 122b . . . 122n of the system. Each port 122a, 122b . . . 122n can include a data transceiver coupled to the network 128. Each device driver 130a, 130b . . . 130n executes in memory 106 and includes network adapter specific commands to communicate with a network controller of the network adapter 112 and interface between the operating system 110, an application 114, and the network adapter 112. The network adapter interfaces 124a, 124b, . . . 124n can each provide an input queue and an output queue for transmitting and receiving instructions between a device driver of the device drivers 130a, 130b . . . 130n and the network adapter 112.

The network controller can implement the network protocol layer and can control other protocol layers including a data link layer and a physical layer which can include hardware such as a data transceiver. In an embodiment employing the Ethernet protocol, the data transceiver could be an Ethernet transceiver.

In certain implementations, the network controller of the network adapter 112 includes a transport protocol layer as well as the network protocol layer and other protocol layers. For example, the network controller of the network adapter 112 can implement a TCP/IP offload engine (TOE), in which many transport layer operations can be performed within the offload engines of the transport protocol layer implemented within the network adapter 112 hardware or firmware, as opposed to the device drivers 130a, 130b . . . 130n or other host software. In the illustrated embodiment, the TOE may be one of a plurality of resources 132a, 132b . . . 132n of the shared resources 120.

The transport protocol operations include packaging data in a TCP/IP packet with a checksum and other information and sending the packets. These sending operations are performed by an agent which may be implemented with a TOE, a network interface card or integrated circuit, a driver, TCP/IP stack, a host processor, host operating system 110, application 114, a shared resource 132a, 132b . . . 132n or a combination of these elements. The transport protocol operations also include receiving a TCP/IP packet from over the network and unpacking the TCP/IP packet to access the payload or data. These receiving operations are performed by an agent which, again, may be implemented with a TOE, a driver, a host processor, host operating system 110, application 114, a shared resource 132a, 132b . . . 132n or a combination of these elements.

The network layer handles network communication and provides received TCP/IP packets to the transport protocol layer. The transport protocol layer interfaces with a device driver 130a, 130b . . . 130n, or operating system 110 or an application 114, and performs additional transport protocol layer operations, such as processing the content of messages included in the packets received at the network adapter 112 that are wrapped in a transport layer, such as TCP and/or IP, the Internet Small Computer System Interface (iSCSI), Fibre Channel SCSI, parallel SCSI transport, or any transport layer protocol known in the art. The transport offload engine of one of the shared resources 132a, 132b . . . 132n can unpack the payload from the received TCP/IP packet and transfer the data to a device driver 130a, 130b . . . 130n, operating system 110 or an application 114.

In certain implementations, the network adapter 112 can further include an RDMA protocol layer as well as the transport protocol layer. For example, the network adapter 112 can implement an RDMA offload engine, in which RDMA layer operations are performed within the offload engines of the RDMA protocol layer implemented within the network adapter 112 hardware or firmware, as opposed to the device driver 120, operating system 110 or an application 114. The RDMA engine may be a shared resource 132a, 132b . . . 132n and may be a part of the TOE or may be a separate engine.

Thus, an application 114 transmitting messages over an RDMA connection can transmit the message through the device driver 130a, 130b . . . 130n and the RDMA protocol layer of the network adapter 112. The data of the message can be sent to the transport protocol layer to be packaged in a TCP/IP packet before transmitting it over the network 118 through the network protocol layer and other protocol layers including the data link and the physical protocol layers.

The memory 106 further includes file objects 144, which also may be referred to as socket objects, which include information on a connection to a remote computer over the network 118. The application 114 uses the information in the file object 144 to identify the connection. The application 114 would use the file object 144 to communicate with a remote system. The file object 144 may indicate the local port or socket that will be used to communicate with a remote system, a local network (IP) address of the computer 102 in which the application 114 executes, how much data has been sent and received by the application 114, and the remote port and network address, e.g., IP address, with which the application 114 communicates. Context information 146 comprises a data structure including information the device driver 130a, 130b . . . 130n, operating system 110 or an application 114, maintains to manage requests sent to the network adapter 112 as described below.

In the illustrated embodiment, the CPU 104 programmed to operate by the software of memory 106 including one or more of the operating system 110, applications 114, and device drivers 130a, 130b . . . 130n provides a host 150 which interacts with the network adapter 112. Accordingly, a data send and receive agent 152 includes the transport protocol layer and the network protocol layer of the network interface 112. However, the data send and receive agent 152 may be implemented with a TOE, a network interface card or integrated circuit, a driver, TCP/IP stack, a host processor, host software, a shared resource 132a, 132b . . . 132n, or a combination of these elements.

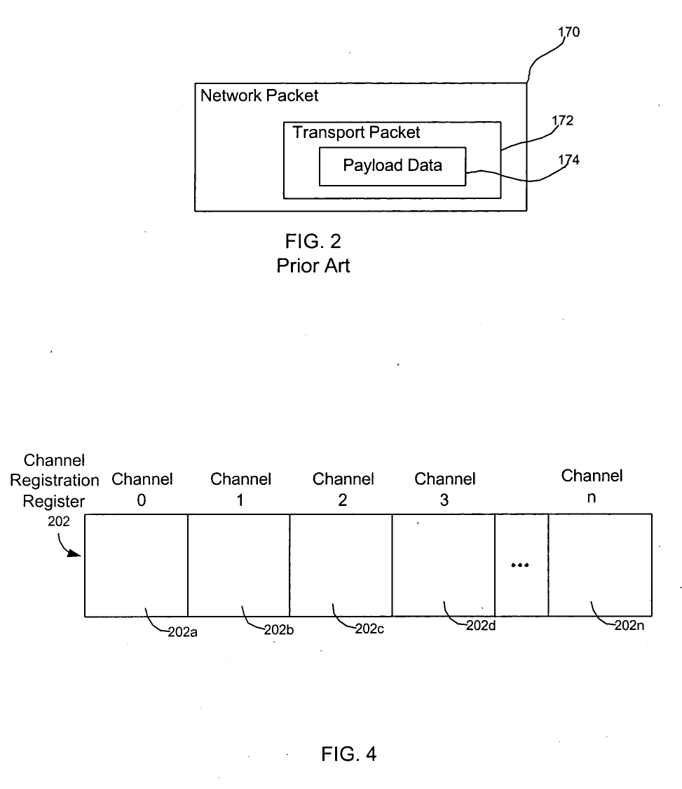

FIG. 2 illustrates a format of a network packet 170 received at or transmitted by the network adapter 112. The network packet 170 is implemented in a format understood by the network protocol layer such as the IP protocol. The network packet 170 may include an Ethernet frame that would include additional Ethernet components, such as a header and error checking code (not shown). A transport packet 172 is included in the network packet 150. The transport packet 172 is capable of being processed by a transport protocol layer, such as the TCP protocol. The packet 152 may be processed by other layers in accordance with other protocols including Internet Small Computer System Interface (iSCSI) protocol, Fibre Channel SCSI, parallel SCSI transport, etc. The transport packet 172 includes payload data 174 as well as other transport layer fields, such as a header and an error checking code. The payload data 172 includes the underlying content being transmitted, e.g., commands, status and/or data. The drivers 130a, 130b . . . 130n, operating system 110, or an application 114 may include a layer, such as a SCSI driver or layer to process the content of the payload data 154 and access any status, commands and/or data therein.

In one aspect, each shared resource 132a, 132b . . . 132n has associated therewith a lock logic 200a, 200b . . . 200n, respectively, which may be used in combination with a channel registration 201 by the device drivers 130a, 130b . . . 130n to coordinate or allocate usage of the shared resources 132a, 132b . . . 132n. As explained in greater detail below, in some applications, such lock logic can obviate the usage of software channels for communication between the device drivers 130a, 130b . . . 130n. The network adapter interfaces 124a, 124b, . . . 124n, channel registration 201 and lock logics 200a, 200b . . . 200n provide multiple separate host interfaces for passing run-time commands between the drivers 130a, 130b . . . 130n and each shared resource 132a, 132b . . . 132n.

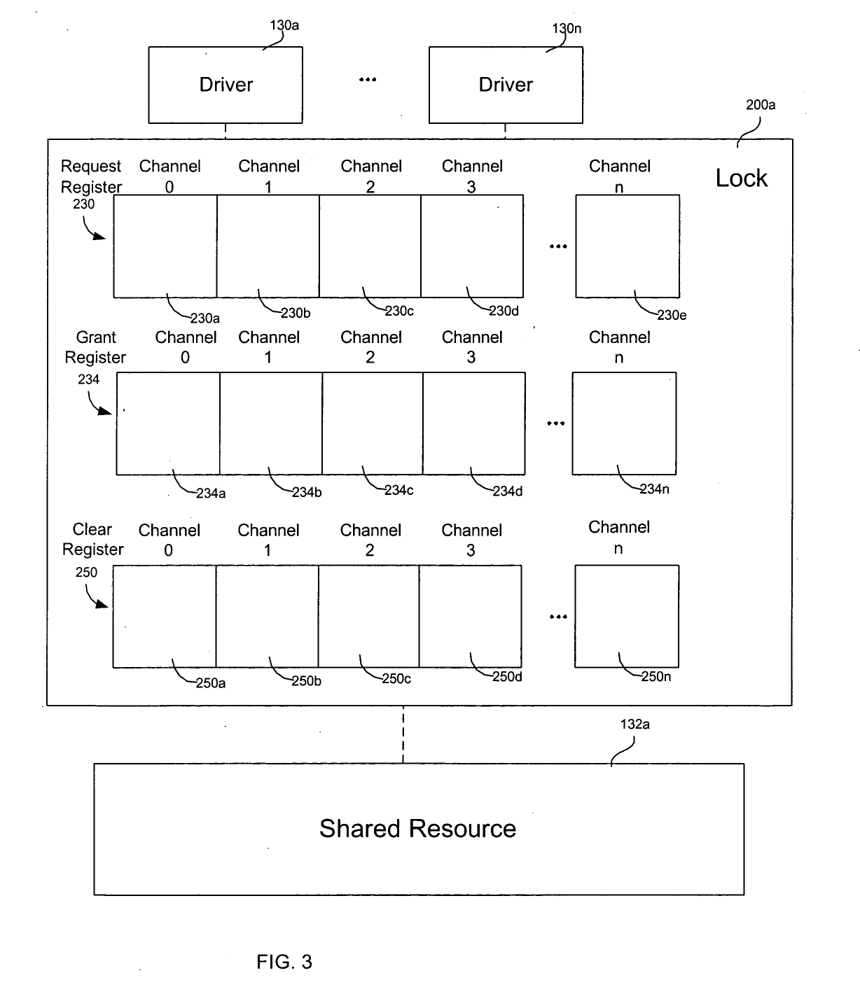

FIG. 3 shows an example of one of the lock logics 200a, 200b . . . 200n, here lock 200a, for one of the shared resources 132a, 132b . . . 132n, here shared resource 132a. In this example, each lock logic 200a, 200b . . . 200n has a plurality of channels 0, 1, 2 . . . n, each of which provides access to the associated resource 132a. Each channel 0, 1, 2 . . . n can be acquired by a particular driver 130a, 130b . . . 130n. As best seen in FIG. 4, each channel 0, 1, 2 . . . n is represented by a bit 202a, 202b . . . 202n of a channel registration register 202 of the channel registration 201 which can be used to identify which channels are in use by a driver. For example, if device driver 130a will be using channel 0 and channel 1 to access the shared resources 132a, 132b . . . 132n, a bit may be written into bits 202a and 202b of the channel registration register 202 to set flags to indicate that channels 0 and 1 are being used by a driver. Similarly, if device driver 130b will be using channel 2 and channel 3 to access the shared resources 132a, 132b . . . 132n, a bit may be written into bits 202c and 202d of the channel registration register 202 to set flags to indicate that channels 2 and 3 are being used by a driver.

When a driver reads the channel registration register 202, and discovers that channels other than the channels selected for its own use are in use, an indication is provided to that driver that other drivers are present. Accordingly, when a driver of the drivers 130a, 130b . . . 130n is loaded, the channel registration register 202 can be read to detect the presence of other drivers and to select an unused channel of the channels 0, 1, 2 . . . n for use of the driver being loaded. Similarly, when a driver of the drivers 130a, 130b . . . 130n is unloaded, the bits of the channel registration register 202 selected by the driver when loaded, can be reset to release the channels for use by other drivers.

In the illustrated embodiment, the channel registration register 202 is a global register used in connection with each of the locks 200a, 200b . . . 200n. However, it is appreciated that in some embodiments, each lock 200a, 200b . . . 200n may use a separate channel registration register 202 for the drivers 130a, 130b . . . 130n to select the channels 0, 1 . . . n of the associated shared resource 132a, 132b . . . 132n.

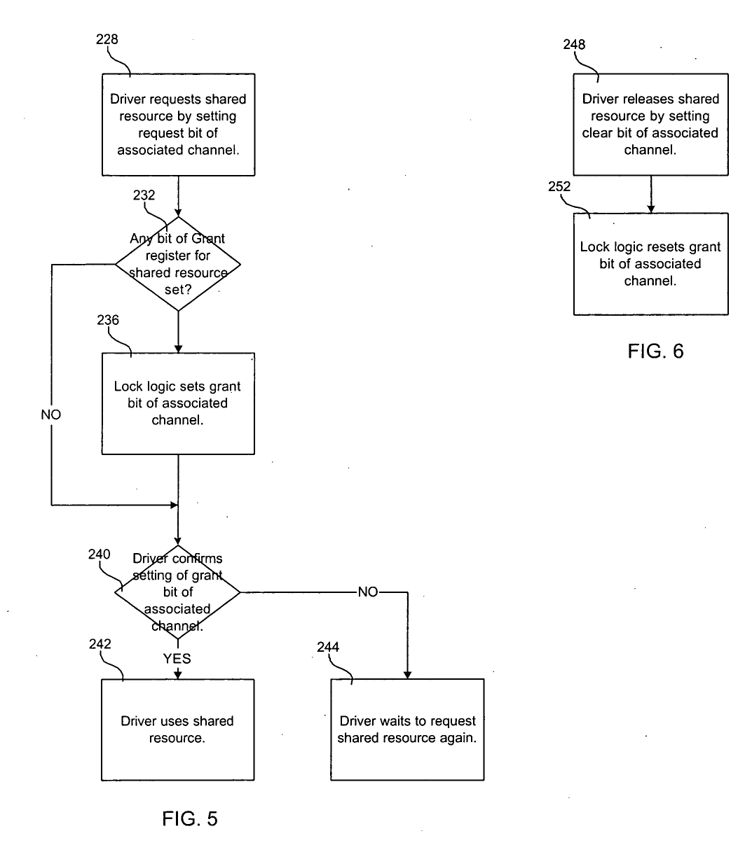

FIG. 5 shows operations of the drivers 130a, 130b . . . 130n and the locks 200a, 200b . . . 200n to acquire a shared resource 132a, 132b . . . 132n for use by that driver. To request a shared resource 132a, 132b . . . 132n, each driver 130a, 130b . . . 130n, sets (block 228) a flag by setting the appropriate channel request bit 230a, 230b . . . 230n (FIG. 3) of a request register 230 of the lock 200a, 200b . . . 200n. Thus, for example, if the driver 130a is requesting the shared resource 132a, the driver 130a selects lock 200a which the driver has associated with resource 132a, and sets one of the request bits 230a, 230b for channels 0 and 1, if the driver 130a set the channel registration register bits 202a and 202b to select channels 0 and 1, respectively, for the driver 130a as discussed above. In this manner, the driver 130a sets a flag in one of its channels 0, 1 to request use of the shared resource 132a.

In response, the selected lock 200a, 200b . . . 200n determines (block 232) if any bit of the channel bits 234a, 234b . . . 234n of a grant register 234 has been set. If not, the selected lock 200a, 200b . . . 200n sets (block 236) the grant bit 234a, 234b . . . 234n of the respective requested channel 0, 1 . . . n. In the above example, if the driver 130a sets (block 236) the request bit 230a of the request register 230 of the lock 200a to request channel 0 of the shared resource 132a, the lock 200a sets the grant bit 234a of the grant register 234 of the lock 200a, thereby providing a flag to the driver 130a that channel 0 of the shared resource 132a has been granted to the driver 130a.

If on the other hand, the selected lock 200a, 200b . . . 200n determines (block 232) that any of the channel bits 234a, 234b . . . 234n of the grant register 234 for the respective channels 0, 1 . . . n has already been set, the selected lock 200a, 200b . . . 200n does not set the grant bit 234a, 234b . . . 234n of the respective requested channel 0, 1 . . . n. In the above example, if the driver 130a sets (block 236) the request bit 230a of the request register 230 of the lock 200a to request channel 0 of the shared resource 132a, the lock 200a does not set the grant bit 234a of the grant register 234 if any of the other grant register channel bits 234b . . . 234n of the lock 200a has already been set. In this manner, if two drivers 130a, 130b . . . 130n request the lock 200a, 200b . . . 200n for the shared resource 132a, 132b . . . 132n at the same time, only one driver 130a, 130b . . . 130n will be granted access to the shared resource 132a, 132b . . . 132n by the associated lock 200a, 200b . . . 200n.

After setting the request bit 230a, 230b . . . 230n for the requested channel 0, 1 . . . n of the shared resource 132a, 132b . . . 132n, the driver 130a, 130b . . . 130n reads the flags of the grant register 234 to confirm (block 240) whether the requested channel 0, 1 . . . n has been granted for the shared resource 132a, 132b . . . 132n. If so, the driver 130a, 130b . . . 130n proceeds to use (block 242) the shared resource 132a, 132b . . . 132n. Otherwise, the driver 130a, 130b . . . 130n waits (block 244) to request the shared resource 132a, 132b . . . 132n again. Thus, in the above example, after the driver 130a sets (block 228) one of the request register channel bits 230a, 230b, for the channels 0, 1, for the shared resource 132a, the driver 130a reads the flags of the grant register channel bits 234a, 234b . . . 234n of the grant register 234 of the lock 200a to confirm (block 240) whether the requested channel 0, 1 has been granted for the shared resource 132a. If so, the driver 130a proceeds to use (block 242) the shared resource 132a. Otherwise, the driver 130a waits (block 244) to request the shared resource 132a again.

In the illustrated embodiment, the drivers 130a, 130b . . . 130n define which lock 200a, 200b . . . 200n is associated with which shared resource 132a, 132b . . . 132n. In addition, the locks 200a, 200b . . . 200n do not physically limit access to any shared resource 132a, 132b . . . 132n by any device driver 130a, 130b . . . 130n. Instead, the drivers 130a, 130b . . . 130n are programmed to respect the locks 200a, 200b . . . 200n and to refrain from accessing a shared resource 132a, 132b . . . 132n until granted access by the defined lock 200a, 200b . . . 200n for that shared resource 132a, 132b . . . 132n. It is appreciated that in other embodiments, each of the locks 200a, 200b . . . 200n can be dedicated by hardware or other software to one particular shared resource of the shared resources 132a, 132b . . . 132n. In addition, the locks 200a, 200b . . . 200n can be provided the capability to limit access to the associated shared resource 132a, 132b . . . 132n.

Once a driver 130a, 130b . . . 130n has finished using a shared resource 132a, 132b . . . 132n, the driver 130a, 130b . . . 130n can release the shared resource 132a, 132b . . . 132n as shown in FIG. 6. To release the shared resource 132a, 132b . . . 132n, the driver 130a, 130b . . . 130n selects the lock 200a, 200b . . . 200n associated with the shared resource 132a, 132b . . . 132n to be released and sets (block 248) a flag by setting a clear register channel bit 250a, 250b . . . 250n of a clear register 250, for the appropriate channel. In response, the lock 200a, 200b . . . 200n clears grant flag by clearing the grant register channel bit 234a, 234b . . . 234n for the channel 0, 1 . . . n associated with the clear register channel bit 250a, 250b . . . 250n set by the driver 130a, 130b . . . 130n.

Thus, in the above example, to release the shared resource 132a, the driver 130a would set (block 248) a clear flag by setting the clear register channel bit 250a for channel 0 of the lock 200a. In response, the lock 200a would clear (block 252) the grant register channel bit 234a for channel 0 of shared resource 132a. As a result, another driver 130a, 130b . . . 130n can request use of the shared resource 132a, 132b . . . 132n by setting a request register channel bit 230a, 230b . . . 230n. In this manner, the locks 200a, 200b . . . 200n can facilitate exclusive access to the associated shared resources 132a, 132b . . . 132n.

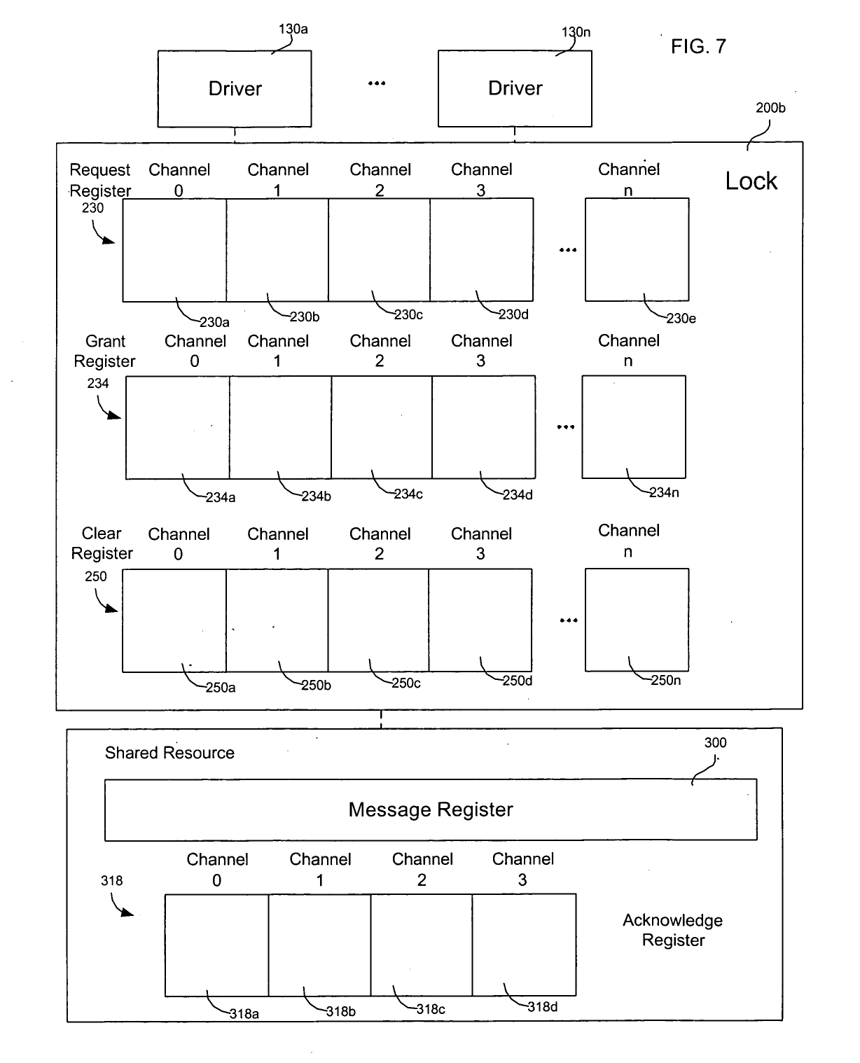

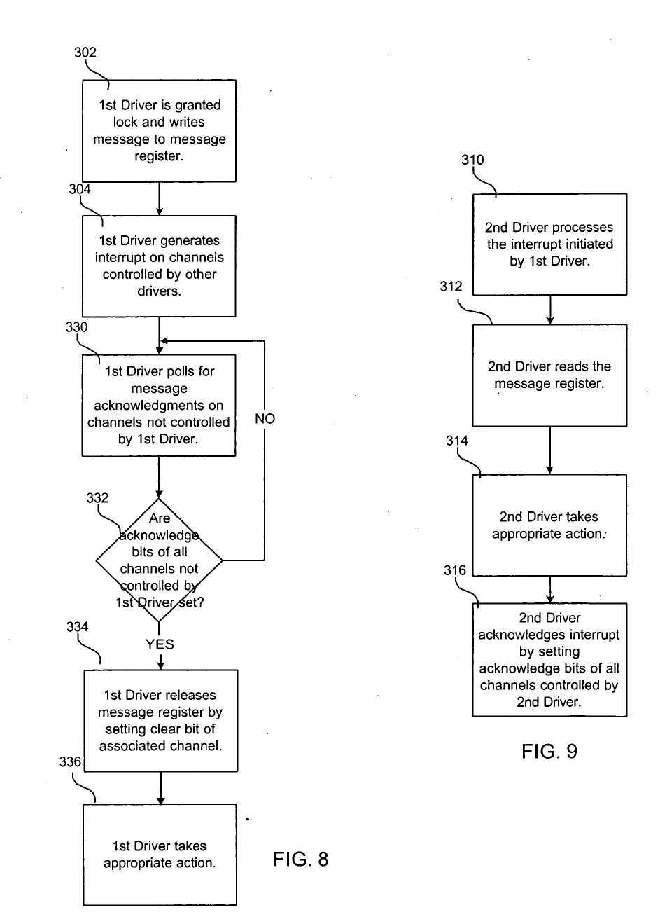

In another aspect, a provision is made for one driver 130a, 130b . . . 130n to pass a message to another driver 130a, 130b . . . 130n, utilizing one of the locks 200a, 200b . . . 200n and one of the shared resources 132a, 132b . . . 132n. FIG. 7 shows a shared resource 132b, for example, which includes a message register 300 in which the driver 130a, 130b . . . 130n initiating the message can write the message once granted access by an associated lock logic 200b. FIG. 8 shows operations of one driver 130a, 130b . . . 130n passing a message to another driver 130a, 130b . . . 130n. This may occur for example when a particular shared resource 132a, 132b . . . 132n or the entire network adapter 112 is to be reset.

In this embodiment, to write a message using the shared message resource 132b, the driver 130a, 130b . . . 130n is granted (block 302) the lock 200b associated with the shared message resource 132b, and writes the message into the message register 300 of the shared message resource 132b. This granting of the lock 200b is performed in the same manner as that described above in connection with FIG. 5. Hence, a driver 130a, 130b . . . 130n, such as driver 130a, for example, selects the lock 200b of the shared resource 132b and requests the shared resource 132b by setting (block 228, FIG. 5) a request flag by setting the appropriate channel request bit 230a, 230b . . . 230n of a request register 230 of the lock 200b. Again, in this example, the driver 130a can set request bits 230a for channel 0 if the driver 130a set the channel registration register bit 202a to select channel 0 for the driver 130a as discussed above.

In response, the lock 200b determines (block 232) if any bit of the channel bits 234a, 234b . . . 234n of the grant register 234 has been set. If not, the lock 200b sets (block 236) the grant flag by setting the grant bit 234a of the requested channel 0.

If on the other hand, the lock 200b determines (block 232) that any of the channel bits 234a, 234b . . . 234n of the grant register 234 has already been set, the lock 200b does notset the grant bit 234a of the requested channel 0. In this manner, if two drivers 130a, 130b . . . 130n request the lock 200b for the shared message resource 132b at the same time, only one driver of the drivers 130a, 130b . . . 130n will be granted access to the shared resource 132b by the associated lock 200b.

After setting the request bit 230a, for the requested channel 0, of the lock 200b for the shared resource 132b, the driver 130a, reads the flags of the grant register 234 to confirm (block 240) whether the requested channel 0 has been granted for the shared resource 132b. If so, the driver 130a proceeds to write (block 242) the message into the message register 300 of the shared resource 132b. Otherwise, the driver 130a waits (block 244) to request the shared message resource 132b again.

Once the message shared resource 132b is granted and the message is written (block 302, FIG. 8) into the message register 300, the driver 130a generates an interrupt (block 304) on the channels controlled by the other drivers of the drivers 130a, 130b . . . 130n. Hence, in this example in which driver 130a controls channels 0 and 1, an interrupt would be generated for the other channels 2, 3 . . . n controlled by the other drivers.

FIG. 9 shows operations of the other drivers of the drivers 130a, 130b . . . 130n in response to an interrupt on one of their channels, in this example, channels 2 . . . n. The other drivers 130b . . . 130n process (block 310) the interrupt initiated by the message writing driver 130a, 130b . . . 130n, here, the first driver 130a. In connection with this processing of the interrupt, the other drivers 130b . . . 130n read (block 312) the message from the message register 300. Each of the other drivers 130b . . . 130n also takes appropriate action (block 314) in response to the message written by the first driver 130a. Thus, for example, if the message written in the register 300 is that the network adapter 112 needs to be reset, the other drivers 130b . . . 130n can save intermediate results and cease using the network adapter in anticipation of the network adapter being reset by the driver 130a.

Each of the other drivers 130b . . . 130n can acknowledge receipt and handling of the message by setting (block 316) an acknowledge flag by setting a bit in the appropriate channel bit or bits 318a, 318b . . . 318n of an acknowledgement register 318 of the message shared resource 132b. Thus, for example, if the second driver 130b controls channels 2 and 3, the driver 130b can set acknowledge register channel bits 318b and 318c upon reading and handling of the message written by the first driver 130a.

Returning to FIG. 8, the message writing driver, driver 130a in this example, following writing (block 302) and generating (block 304) the interrupts for the other driver channels, polls (block 330) for acknowledgments by the other drivers 130b . . . 130n of the interrupts issued on the channels 2, 3 . . . n not controlled by the driver 130a. In the illustrated embodiment, this is achieved by the driver 130a reading the acknowledgment register channel bits 318c . . . 318n to confirm that the acknowledgment flags, that is, the register channel bits 318c . . . 318n have been set by the other drivers 130b . . . 130n.

If it is determined (block 332) that not all of the acknowledgment register channel bits 318c . . . 318n controlled by drivers 130b . . . 130n other than the driver 130a, have been set, the driver 130a continues to poll (block 330) for acknowledgments. Once it is determined (block 332) all of the acknowledgment register channel bits 318c . . . 318n controlled by drivers 130b . . . 130n other than the message writing driver 130a, have been set, the driver 130a releases (block 334) the shared resource 132b including the message register 300 in the manner described above in connection with FIG. 6. Thus, in this example, the message writing driver 130a would set (block 248, FIG. 6) the clear flag by setting the clear register channel bit 250a for channel 0 of the lock 200b for the message shared resource 132b. In response, the lock 200b clears (block 252) the grant register channel bit 234a for channel 0 of shared resource 132b. As a result, another driver 130a, 130b . . . 130n can request use of the shared resource 132b by setting a request register channel bit 230a, 230b . . . 230n of the message shared resource 132b.

Returning to FIG. 8, upon receiving (block 330) acknowledgments by the other drivers 130b . . . 130n of the interrupts issued on the channels 2, 3 . . . n (block 332) not controlled by the driver 130a, the driver 130a can take (block 336) the appropriate action. This appropriate action may be, for example, resetting the network adapter 112.

### Additional Embodiment Details

The described techniques for managing memory may be implemented as a method, apparatus or article of manufacture using standard programming and/or engineering techniques to produce software, firmware, hardware, or any combination thereof. The term “article of manufacture” as used herein refers to code or logic implemented in hardware logic (e.g., an integrated circuit chip, Programmable Gate Array (PGA), Application Specific Integrated Circuit (ASIC), etc.) or a computer readable medium, such as magnetic storage medium (e.g., hard disk drives, floppy disks, tape, etc.), optical storage (CD-ROMs, optical disks, etc.), volatile and non-volatile memory devices (e.g., EEPROMs, ROMs, PROMs, RAMs, DRAMs, SRAMs, firmware, programmable logic, etc.). Code in the computer readable medium is accessed and executed by a processor. The code in which preferred embodiments are implemented may further be accessible through a transmission media or from a file server over a network. In such cases, the article of manufacture in which the code is implemented may comprise a transmission media, such as a network transmission line, wireless transmission media, signals propagating through space, radio waves, infrared signals, etc. Thus, the “article of manufacture” may comprise the medium in which the code is embodied. Additionally, the “article of manufacture” may comprise a combination of hardware and software components in which the code is embodied, processed, and executed. Of course, those skilled in the art will recognize that many modifications may be made to this configuration without departing from the scope of the present invention, and that the article of manufacture may comprise any information bearing medium known in the art.

In the described embodiments, certain operations were described as being performed by the operating system 110, system host 150, device drivers 130a, 130b . . . 130 n, or the network interface 112. In alterative embodiments, operations described as performed by one of these may be performed by one or more of the operating system 110, device drivers 130a, 130b . . . 130n, or the network interface 112 in various combinations. For example, memory operations described as being performed by the driver may be performed by the host.

In the described implementations, a transport protocol layer was implemented in the network adapter 112 hardware. In alternative implementations, the transport protocol layer may be implemented in the device driver or host memory 106.

In the described embodiments, various protocol layers and operations of those protocol layers were described. The operations of each of the various protocol layers may be implemented in hardware, firmware, drivers, operating systems, applications or other software, in whole or in part, alone or in various combinations thereof.

In the described embodiments, the packets are transmitted from a network adapter to a remote computer over a network. In alternative embodiments, the transmitted and received packets processed by the protocol layers or device driver may be transmitted to a separate process executing in the same computer in which the device driver and transport protocol driver execute. In such embodiments, the network adapter is not used as the packets are passed between processes within the same computer and/or operating system.

In certain implementations, the device driver and network adapter embodiments may be included in a computer system including a storage controller, such as a SCSI, Integrated Drive Electronics (IDE), Redundant Array of Independent Disk (RAID), etc., controller, that manages access to a non-volatile storage device, such as a magnetic disk drive, tape media, optical disk, etc. In alternative implementations, the network adapter embodiments may be included in a system that does not include a storage controller, such as certain hubs and switches.

In certain implementations, the device driver and network adapter embodiments may be implemented in a computer system including a video controller to render information to display on a monitor coupled to the computer system including the device driver and network adapter, such as a computer system comprising a desktop, workstation, server, mainframe, laptop, handheld computer, etc. Alternatively, the network adapter and device driver embodiments may be implemented in a computing device that does not include a video controller, such as a switch, router, etc.

In certain implementations, the network adapter may be configured to transmit data across a cable connected to a port on the network adapter. Alternatively, the network adapter embodiments may be configured to transmit data over a wireless network or connection, such as wireless LAN, Bluetooth, etc.

The illustrated logic of FIGS. 5, 6, 8-9 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

FIGS. 3, 7 illustrates logic used to manage shared resources. In alternative implementation, these structures may include additional or different structures than illustrated in the figures.

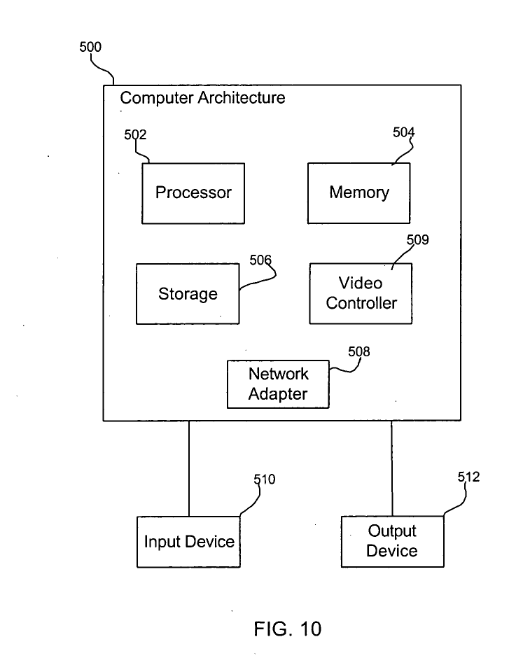

FIG. 10 illustrates one implementation of a computer architecture 500 of a computer 104. The architecture 500 may include a processor 502 (e.g., a microprocessor), a memory 504 (e.g., a volatile memory device), and storage 506 (e.g., a non-volatile storage, such as magnetic disk drives, optical disk drives, a tape drive, etc.). The storage 506 may comprise an internal storage device or an attached or network accessible storage. Programs in the storage 506 are loaded into the memory 504 and executed by the processor 502 in a manner known in the art. The architecture further includes a network adapter 508 to enable communication with a network, such as an Ethernet, a Fibre Channel Arbitrated Loop, etc. Further, the architecture may, in certain embodiments, include a video controller 509 to render information on a display monitor, where the video controller 509 may be implemented on a video card or integrated on integrated circuit components mounted on the motherboard. As discussed, certain of the network devices may have multiple network cards or controllers. An input device 510 is used to provide user input to the processor 502, and may include a keyboard, mouse, pen-stylus, microphone, touch sensitive display screen, or any other activation or input mechanism known in the art. An output device 512 is capable of rendering information transmitted from the processor 502, or other component, such as a display monitor, printer, storage, etc.

The network adapter 508 may be implemented on a network card, such as a Peripheral Component Interconnect (PCI) card or some other I/O card, or on integrated circuit components mounted on the motherboard.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

1. A method, comprising:
setting a request flag in a lock logic associated with a shared resource of a device;
reading a grant flag set in response to said request flag in said lock logic; and
using said shared resource in response to said set grant flag.

2. The method of claim 1 wherein a first driver for said device sets said request flag, reads said grant flag and uses said shared resource in response to said set grant flag.

3. The method of claim 2 wherein said device is a network adapter and said shared resource is a transport offload engine.

4. The method of claim 2 wherein said first device is a network adapter and said shared resource is a message register, said method further comprising said first driver writing a message to another driver of said device.

5. The method of claim 4 wherein said shared resource further comprises an acknowledgment register, said method further comprising said first driver interrupting said other driver, said other driver reading in response to said interrupts, said message in said message register; and setting an acknowledgment flag in said acknowledgment register to acknowledge that said other driver has read said message.

6. The method of claim 5 wherein said message is that said network adapter is going to be reset, said method further comprising said first driver resetting said network adapter in response to said acknowledgment flag set in said acknowledgment register.

7. The method of claim 2 further comprising said first driver setting a clear flag in said lock logic after said shared resource is used and said lock logic resetting said grant flag in response to said clear flag.

8. The method of claim 7 wherein said device is a network adapter and said lock logic has a plurality of channels and a request register, a grant register and a clear register in said network adapter, each register having a flag bit for each channel wherein a flag is set by setting a flag bit in a register of said registers.

9. The method of claim 8 wherein in response to a driver of said network adapter setting a request flag by setting a bit in said request register for a particular channel, said lock logic sets a grant flag by setting a flag bit in said grant register for said particular channel if no other flag bit in said grant register is set, and wherein in response to a driver setting a clear flag by setting a flag bit in said clear register for said particular channel, said lock logic resets a flag bit in said grant register for said particular channel.

10. The method of claim 9 wherein said shared resource is a message register and an acknowledgment register having a flag bit for each channel, said method further comprising said first driver writing a message to another driver of said network adapter in said message register, and interrupting said other driver, and said other driver reading in response to said interrupt, said message in said message register; and setting an acknowledgment flag by setting a flag bit in said acknowledgment register for each channel used by said other driver to acknowledging that said other driver has read said message.

11. The method of claim 1 wherein said lock logic has a plurality of channels, the method further comprising a plurality of drivers each setting a channel registration flag in a channel registration register of said lock logic to indicate that a channel of the lock logic is associated with the driver.

12. An article comprising a storage medium, the storage medium comprising machine readable instructions stored thereon to:
set a request flag in a lock logic associated with a shared resource of a device;
read a grant flag set in response to said request flag in said lock logic; and
use said shared resource in response to said set grant flag.

13. The article of claim 12 wherein the storage medium further comprises machine readable instructions stored thereon for a first driver for said device to set said request flag, read said grant flag and use said shared resource in response to said set grant flag.

14. The article of claim 13 wherein said device is a network adapter and said shared resource is a transport offload engine.

15. The article of claim 13 wherein said device is a network adapter and said shared resource is a message register, and wherein the storage medium further comprises machine readable instructions stored thereon for said first driver to write a message to another driver of said device.

16. The article of claim 15 wherein said shared resource further comprises an acknowledgment register, and wherein the storage medium further comprises machine readable instructions stored thereon for said first driver to interrupt said other driver, and for said other driver to read in response to said interrupt, said message in said message register, and to set an acknowledgment flag in said acknowledgment register to acknowledge that said other driver has read said message.

17. The article of claim 16 wherein said message is that said network adapter is going to be reset, and wherein the storage medium further comprises machine readable instructions stored thereon for said first driver to reset said network adapter in response to said acknowledgment flag set in said acknowledgment register.

18. The article of claim 13 wherein the storage medium further comprises machine readable instructions stored thereon for said first driver to set a clear flag in said lock logic after said shared resource is used and wherein the storage medium further comprises machine readable instructions stored thereon for said lock logic to reset said grant flag in response to said clear flag.

19. The article of claim 18 wherein said device is a network adapter and said lock logic has a plurality of channels and a request register, a grant register and a clear register in said network adapter, each register having a flag bit for each channel wherein a flag is set by setting a flag bit in a register of said registers.

20. The article of claim 19 wherein the storage medium further comprises machine readable instructions stored thereon for said lock logic to, in response to a driver of said network adapter setting a request flag by setting a bit in said request register for a particular channel, set a grant flag by setting a flag bit in said grant register for said particular channel if no other flag bit in said grant register is set, and in response to a driver setting a clear flag by setting a flag bit in said clear register for said particular channel, reset a flag bit in said grant register for said particular channel.

21. The article of claim 20 wherein said shared resource is a message register and an acknowledgment register having a flag bit for each channel, and wherein the storage medium further comprises machine readable instructions stored thereon for said first driver to write a message to another driver of said network adapter in said message register, and to interrupt said other driver, and wherein the storage medium further comprises machine readable instructions stored thereon for said other driver to read in response to said interrupt, said message in said message register; and set an acknowledgment flag by setting a flag bit in said acknowledgment register for each channel used by said other driver to acknowledging that said other driver has read said message.

22. The article of claim 12 wherein said lock logic has a plurality of channels, and wherein the storage medium further comprises machine readable instructions stored thereon for a plurality of drivers to each set a channel registration flag in a channel registration register of said lock logic to indicate that a channel of the lock logic is associated with the driver.

23. A system for use with a network, comprising:
at least one memory which includes an operating system;
a processor coupled to the memory;
data storage;
a data storage controller for managing Input/Output (I/O) access to the data storage;
a network adapter having a shared resource and a lock logic for said shared resource; and
a first device driver executable by the processor in the memory, wherein the device driver is adapted to:
set a request flag in the lock logic;
read a grant flag set in response to said request flag in said lock logic; and
use said shared resource in response to said set grant flag.

24. The system of claim 23 wherein said device driver is a network adapter driver and said shared resource is a transport offload engine.

25. The system of claim 23 wherein said network controller has another device driver and said shared resource is a message register, and wherein said first device driver is further adapted to write a message to said other device driver.

26. The system of claim 25 wherein said shared resource further comprises an acknowledgment register, and wherein said first device driver is further adapted to interrupt said other driver, and wherein said other device driver is further adapted to read in response to said interrupt, said message in said message register, and to set an acknowledgment flag in said acknowledgment register to acknowledge that said other driver has read said message.

27. The system of claim 26 wherein said message is that said network adapter is going to be reset, and wherein said first driver is further adapted to reset said network adapter in response to said acknowledgment flag set in said acknowledgment register.

28. The system of claim 23 wherein said first driver is further adapted to set a clear flag in said lock logic after said shared resource is used and wherein the lock logic is adapted to reset said grant flag in response to said clear flag.

29. The system of claim 28 wherein said lock logic has a plurality of channels and a request register, a grant register and a clear register in said network adapter, each register having a flag bit for each channel wherein a flag is set by setting a flag bit in a register of said registers.

30. The system of claim 29 wherein said lock logic is further adapted to, in response to a driver of said network adapter setting a request flag by setting a bit in said request register for a particular channel, set a grant flag by setting a flag bit in said grant register for said particular channel if no other flag bit in said grant register is set, and in response to a driver setting a clear flag by setting a flag bit in said clear register for said particular channel, reset a flag bit in said grant register for said particular channel.

31. The system of claim 30 wherein said shared resource is a message register and an acknowledgment register having a flag bit for each channel, and said first driver is further adapted to write a message to said other driver of said network adapter in said message register, and to interrupt said other driver, and wherein said other driver is adapted to read in response to said interrupt, said message in said message register; and set an acknowledgment flag by setting a flag bit in said acknowledgment register for each channel used by said other driver to acknowledging that said other driver has read said message.

32. The system of claim 23 wherein said network controller has another device driver and said lock logic has a plurality of channels, and wherein each device driver is adapted set a channel registration flag in a channel registration register of said lock logic to indicate that a channel of the lock logic is associated with the driver.

33. The system of claim 23 for use with an unshielded twisted pair cable, said system further comprising an Ethernet data transceiver coupled to said network adapter and said cable and adapted to transmit and receive data over said cable.

34. The system of claim 23 further comprising a video controller coupled to said processor.

35. A network adapter for use with a network and a plurality of network adapter drivers, comprising:
a shared resource adapted to be used by said plurality of drivers; and
lock logic means for allocating usage of said shared resource by said plurality of drivers, said lock logic means having a plurality of channels, each channel having:
request flag register means for storing a request flag set by a driver requesting use of said shared resource; and
grant flag register means, responsive to a request flag set by a driver in said request flag register means, for setting a grant flag in said grant flag register means if another grant flag has not been concurrently set for another channel, to indicate that the shared resource may be used by the requesting driver.

36. The network adapter of claim 35 wherein said shared resource is a transport offload engine.

37. The network adapter of claim 35 wherein said shared resource includes a message register means for storing a message from one of said drivers.

38. The network adapter of claim 37 wherein said shared resource further includes an acknowledgment register means for storing an acknowledgment flag set by a driver acknowledging that the driver has read said message.

39. The network adapter of claim 35 wherein each channel further has clear flag register means for storing a clear flag set by a driver after said shared resource is used, said lock logic means having means for resetting said grant flag in said grant flag register means in response to said clear flag.

40. The network adapter of claim 39 wherein each register means has a flag bit for a channel wherein a flag is set by setting a flag bit in the register.

41. The network adapter of claim 35 wherein each channel further has channel registration register means for storing a channel registration flag bit set by a device driver to indicate that the channel is being used by a driver.

42. A network adapter for use with a network and a plurality of network adapter drivers, comprising:
a shared resource adapted to be used by said plurality of drivers; and
lock logic having a plurality of channels, each channel having:
a request flag register adapted to store a request flag set by a driver requesting use of said shared resource; and
a grant flag register adapted to in response to a request flag set by a driver in said request flag register, set a grant flag in said grant flag register if another grant flag has not been concurrently set for another channel, to indicate that the shared resource may be used by the requesting driver.

43. The network adapter of claim 42 wherein said shared resource is a transport offload engine.

44. The network adapter of claim 42 wherein said shared resource includes a message register adapted to store a message from one of said drivers.

45. The network adapter of claim 44 wherein said shared resource further includes an acknowledgment register adapted to store an acknowledgment flag set by a driver acknowledging that the driver has read said message.

46. The network adapter of claim 42 wherein each channel further has a clear flag register adapted to store a clear flag set by a driver after said shared resource is used, said lock logic being adapted to reset said grant flag in said grant flag register in response to said clear flag.

47. The network adapter of claim 46 wherein each register has a flag bit for a channel wherein a flag is set by setting a flag bit in the register.

48. The network adapter of claim 42 wherein each channel further has a channel registration register adapted to store a channel registration flag bit set by a device driver to indicate that the channel is being used by a driver.
